(19) United States
(12) Patent Application Publication
(10) Pub. No.: US 2006/0256233 A1
(43) Pub. Date: Nov. 16, 2006

(54) Systems, methods, and apparatus for video encoding

(76) Inventor: Douglas Chin, Haverhill, MA (US)

Correspondence Address: MCANDREWS HELD & MALLOY, LTD, 500 WEST MADISON STREET, SUITE 3400, CHICAGO, IL, 60661, US

(21) Appl. No.: 11/412,271

(22) Filed: Apr. 27, 2006

Related U.S. Application Data
(60) Provisional application No. 60/681,670, filed on May 16, 2005.

(51) Int. Cl. H04N 7/12

(52) U.S. Cl. 348/390.1

(57) ABSTRACT

Presented herein are systems, methods, and apparatus for real-time high definition television encoding. In one embodiment, there is a method for encoding video data. The method comprises estimating amounts of data for encoding a plurality of pictures in parallel. A plurality of target rates are generated corresponding to the plurality of pictures and based on the estimated amounts of data for encoding the plurality of pictures. The plurality of pictures are then lossy compressed based on the target rates corresponding to the plurality of pictures.

### RELATED APPLICATIONS

This application claims priority to “Systems, Methods, and Apparatus for Real-Time High Definition Video Encoding”, Provisional Application Ser. No. 60/681,670, filed May 16, 2005, and incorporated herein by reference for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Advanced Video Coding (AVC) (also referred to as H.264 and MPEG-4, Part 10) can be used to compress video content for transmission and storage, thereby saving bandwidth and memory. However, encoding in accordance with AVC can be computationally intense.

In certain applications, for example, live broadcasts, it is desirable to compress video in accordance with AVC in real time. However, the computationally intense nature of AVC operations in real time may exhaust the processing capabilities of certain processors. Parallel processing may be used to achieve real time AVC encoding, where the AVC operations are divided and distributed to multiple instances of hardware which perform the distributed AVC operations, simultaneously.

Ideally, the throughput can be multiplied by the number of instances of the hardware. However, in cases where a first operation is dependent on the results of a second operation, the first operation may not be executable simultaneously with the second operation. In contrast, the performance of the first operation may have to wait for completion of the second operation.

AVC uses temporal coding to compress video data. Temporal coding divides a picture into blocks and encodes the blocks using similar blocks from other pictures, known as reference pictures. To achieve the foregoing, the encoder searches the reference picture for a similar block. This is known as motion estimation. At the decoder, the block is reconstructed from the reference picture. However, the decoder uses a reconstructed reference picture. The reconstructed reference picture is different, albeit imperceptibly, from the original reference picture. Therefore, the encoder uses encoded and reconstructed reference pictures for motion estimation.

Using encoded and reconstructed reference pictures for motion estimation causes encoding of a picture to be dependent on the encoding of the reference pictures. This is can be disadvantageous for parallel processing.

Additional limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Aspects of the present invention may be found in a system, method, and/or apparatus for encoding video data in real time, substantially as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram of an exemplary computer system for encoding video data in accordance with an embodiment of the present invention;

FIG. 2 is a flow diagram for encoding video data in accordance with an embodiment of the present invention;

FIG. 3A is a block diagram describing spatially predicted macroblocks;

FIG. 3B is a block diagram describing temporally predicted macroblocks;

FIG. 4 is a block diagram describing the encoding of a prediction error;

FIG. 5 is a block diagram of a system for encoding video data in accordance with an embodiment of the present invention; and

FIG. 6 is a flow diagram for encoding video data in accordance with an embodiment of the present invention.

### DETAILED DESCRIPTION OF THE INVENTION

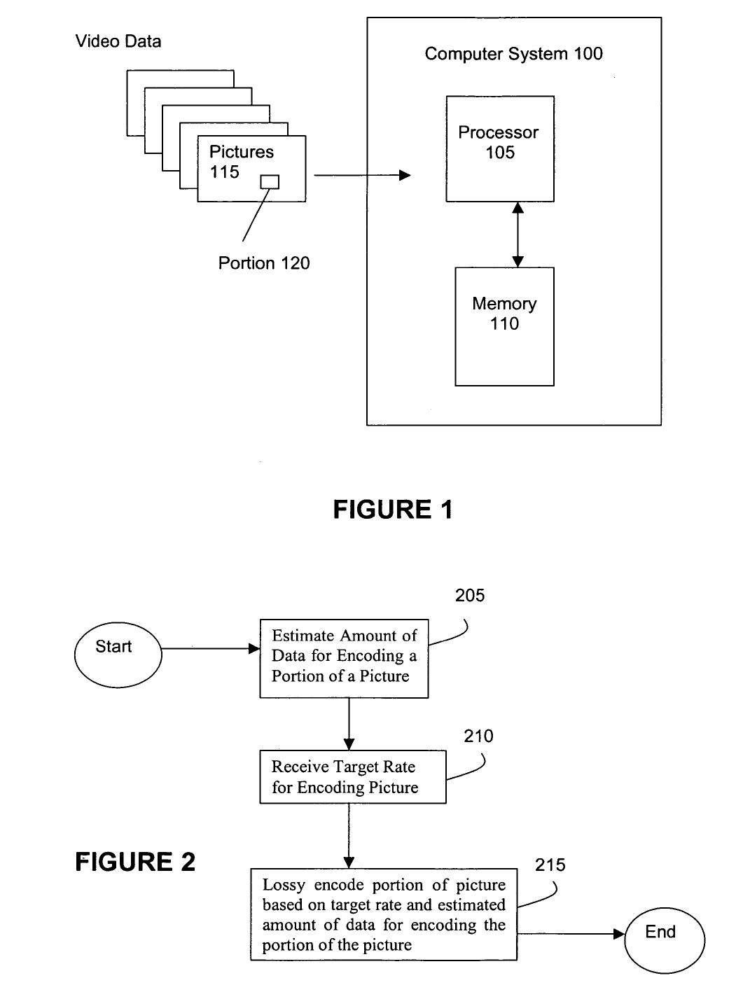

Referring now to FIG. 1, there is illustrated a block diagram of an exemplary computer system 100 for encoding video data 102 in accordance with an embodiment of the present invention. The video data comprises pictures 115. The pictures 115 comprise portions 120. The portions 120 can comprise, for example, a two-dimensional grid of pixels. The pixels can be represent a particular color hue, such as luma, chroma red, or chroma blue.

The computer system 100 comprises a processor 105 and a memory 110 for storing instructions that are executable by the processor 105. When the processor 105 executes the instructions, the processor estimates an amount of data for encoding a portion of a picture.

The estimate of the amount of data for encoding a portion 120 of the picture 115 can be based on a variety of factors. In certain embodiments of the present invention, the estimate of the portion 120 of the picture 115 can be based on a comparison of the portion 120 of the picture 115 to portions of other original pictures 115. In a variety of encoding standards, such as MPEG-2, AVC, and VC-1, portions 120 of a picture 115 are encoded with reference to portions of other encoded pictures 115. The amount of data for encoding the portion 120 is dependent on the similarity or dissimilarity of the portion 120 to the portions of the other encoded pictures 115. The amount of data for encoding the portion 120 can be estimated by examining the original reference pictures 115 for the best portions and measuring the similarities or dissimilarities, therebetween.

The estimated amount of data for encoding the portion 120 can also include, for example, content sensitivity, measures of complexity of the pictures and/or the blocks therein, and the similarity of blocks in the pictures to candidate blocks in reference pictures. Content sensitivity measures the likelihood that information loss is perceivable, based on the content of the video data. For example, in video data, human faces are likely to be more closely examined than animal faces. In certain embodiments of the present invention, the foregoing factors can be used to bias the estimated amount of data for encoding the portion 120 based on the similarities or dissimilarities to portions of other original pictures.

Additionally, the computer system 100 receives a target rate for encoding the picture. The target rate can be provided by either an external system or the computer system 100 that budgets data for the video to different pictures. For example, in certain applications, it is desirable to compress the video data for storage to a limited capacity memory or for transmission over a limited bandwidth communication channel. Accordingly, the external system or computer system 100 budgets limited data bits to the video. Additionally, the amount of data encoding different pictures 115 in the video can vary. As well, based on a variety of characteristics, different pictures 115 and different portions 120 of a picture 115 can offer differing levels of quality for a given amount of data. Thus, the data bits can be budgeted accordingly to these factors.

In certain embodiments of the present invention, the target rate for the picture 115 can be based on the estimated data for encoding the portion 120. Alternatively, the computer system 100 can estimate amounts of data for encoding each of the portions 120 forming the picture 115. The target rate can be based on the estimated amounts of data for encoding each of the portions 120 forming the picture 115.

Based on the target rate for the pictures 115 and the estimated amount of data for encoding the portion 120 of the picture, the portion of the picture is lossy encoded. Lossy encoding involves trade-off between quality and compression. Generally, the more information that is lost during lossy compression, the better the compression rate, but, the more the likelihood that the information loss perceptually changes the portion 120 of the picture 115 and reduces quality.

Referring now to FIG. 2, there is illustrated a flow diagram for encoding a picture in accordance with an embodiment of the present invention. At 205, an amount of data for encoding a portion of the picture is estimated. At 210 a target rate for encoding the picture is received. At 215, the portion of the picture is lossy encoded, based on the target rate and the estimated amount of data for encoding the portion of the picture.

Embodiments of the present invention will now be presented in the context of an exemplary video encoding standard, Advanced Video Coding (AVC) (also known as MPEG-4, Part 10, and H.264). A brief description of AVC will be presented, followed by embodiments of the present invention in the context of AVC. It is noted, however, that the present invention is by no means limited to AVC and can be applied in the context of a variety of encoding standards.

Advanced Video Coding

Advanced Video Coding (also known as H.264 and MPEG-4, Part 10) generally provides for the compression of video data by dividing video pictures into fixed size blocks, known as macroblocks. The macroblocks can then be further divided into smaller partitions with varying dimensions.

The partitions can then be encoded, by selecting a method of prediction and then encoding what is known as a prediction error. AVC provides two types of predictors, temporal and spatial. The temporal prediction uses a motion vector to identify a same size block in another picture and the spatial predictor generates a prediction using one of a number of algorithms that transform surrounding pixel values into a prediction. Note that the data coded includes the information needed to specify the type of prediction, for example, which reference frame, partition size, spatial prediction mode etc.

The reference pixels can either comprise pixels from the same picture or a different picture. Where the reference block is from the same picture, the partition 430 is spatially predicted. Where the reference block is from another picture, the partition 430 is temporally predicted.

Spatial Prediction

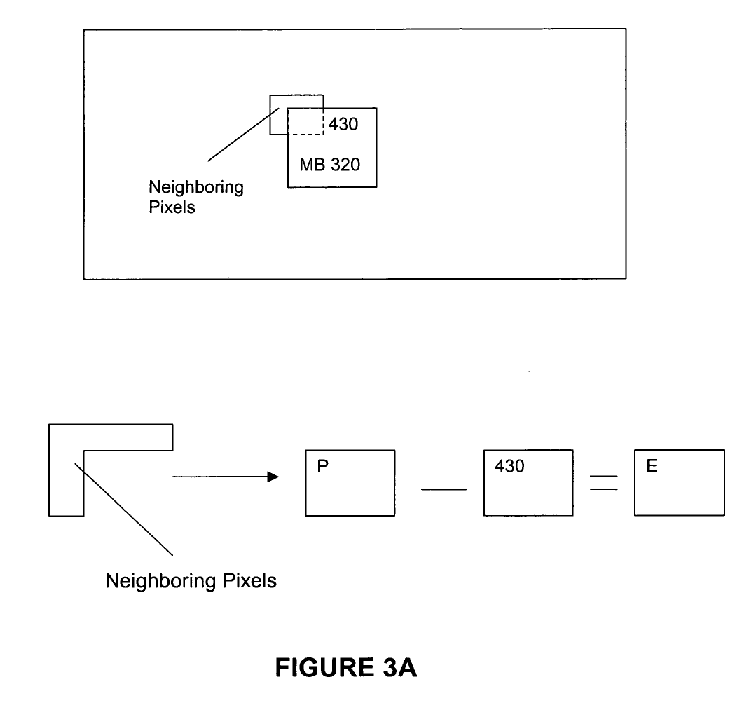

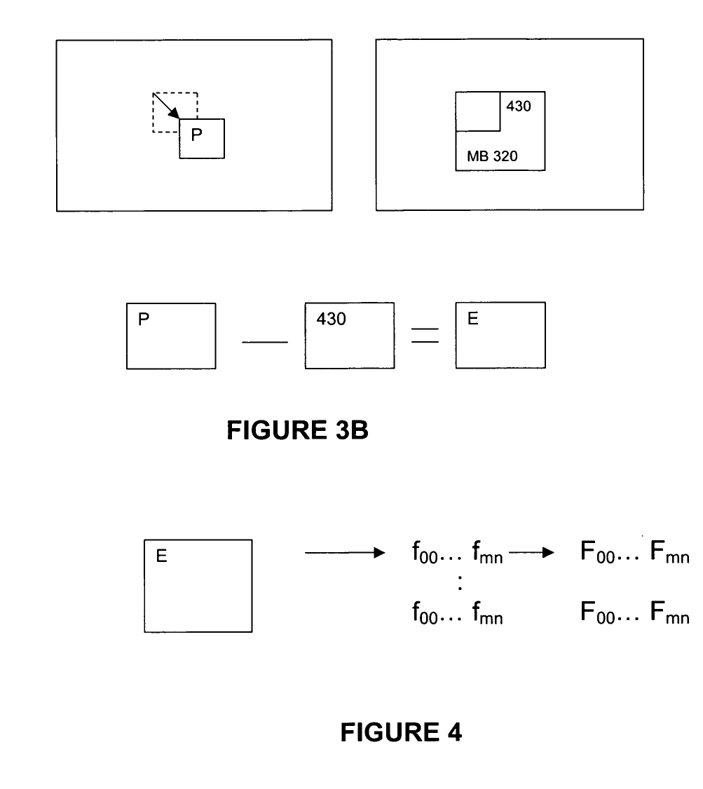

Referring now to FIG. 3A, there is illustrated a block diagram describing spatially encoded macroblocks 320. Spatial prediction, also referred to as intra prediction, is used by H.264 and involves prediction of pixels from neighboring pixels. Prediction pixels are generated from the neighboring pixels in any one of a variety of ways.

The difference between the actual pixels of the partition 430 and the prediction pixels P generated from the neighboring pixels is known as the prediction error E. The prediction error E is calculated and encoded.

Temporal Prediction

Referring now to FIG. 3B, there is illustrated a block diagram describing temporally prediction. With temporal prediction, partitions 430 are predicted by finding a partition of the same size and shape in a previously encoded reference frame. Additionally, the predicted pixels can be interpolated from pixels in the frame or field, with as much as ¼ pixel resolution in each direction. A macroblock 320 is encoded as the combination of data that specifies the derivation of the reference pixels P and the prediction errors E representing its partitions 430. The process of searching for the similar block of predicted pixels P in pictures is known as motion estimation.

The similar block of pixels is known as the predicted block P. The difference between the block 430 and the predicted block P is known as the prediction error E. The prediction error E is calculated and encoded, along with an identification of the predicted block P. The predicted blocks P are identified by motion vectors MV and the reference frame they came from. Motion vectors MV describe the spatial displacement between the block 430 and the predicted block P.

Transformation, Quantization, and Scanning

Referring now to FIG. 4, there is illustrated a block diagram describing the encoding of the prediction error E. With both spatial prediction and temporal prediction, the macroblock 320 is represented by a prediction error E. The prediction error E is a two-dimensional grid of pixel values for the luma Y, chroma red Cr, and chroma blue Cb components with the same dimensions as the macroblock 320, like the macroblock.

A transformation transforms the prediction errors E 430 to the frequency domain. In H.264, the blocks can be 4×4, or 8×8. The foregoing results in sets of frequency coefficients f₀₀ . . . fₘₙ, with the same dimensions as the block size. The sets of frequency coefficients are then quantized, resulting in sets 440 of quantized frequency coefficients, F₀₀ . . . Fₘₙ.

Quantization is a lossy compression technique where the amount of information that is lost depends on the quantization parameters. The information loss is a tradeoff for greater compression. In general, the greater the information loss, the greater the compression, but, also, the greater the likelihood of perceptual differences between the encoded video data, and the original video data.

The pictures are encoded as the portions forming them. The video sequence is encoded as the frames forming it. The encoded video sequence is known as a video elementary stream. Transmission of the video elementary stream instead of the original video consumes substantially less bandwidth.

Due to the lossy compression, the quantization of the frequency components, there is a loss of information between the encoded and decoded (reconstructed) pictures 115 and the original pictures 115 of the video data. Ideally, the loss of information does not result in perceptual differences. As noted above, both spatially and temporally encoded pictures are predicted from predicted blocks P of pixels. When the spatially and temporally encoded pictures are decoded and reconstructed, the decoder uses blocks of reconstructed pixels P from reconstructed pictures. Predicting from predicted blocks of pixels P in original pictures can result in accumulation of information loss between both the reference picture and the picture to be predicted. Accordingly, during spatial and temporal encoding, the encoder uses predicted blocks P of pixels from reconstructed pictures.

Motion estimating entirely from reconstructed pictures creates data dependencies between the compression of the predicted picture and the predicted picture. This is particularly disadvantageous because exhaustive motion estimation is very computationally intense.

According to certain aspects of the present invention, the process of estimating the amount of data for encoding the pictures can be used to assist and reduce the amount of time for compression of the pictures. This is especially beneficial because the estimations are performed in parallel.

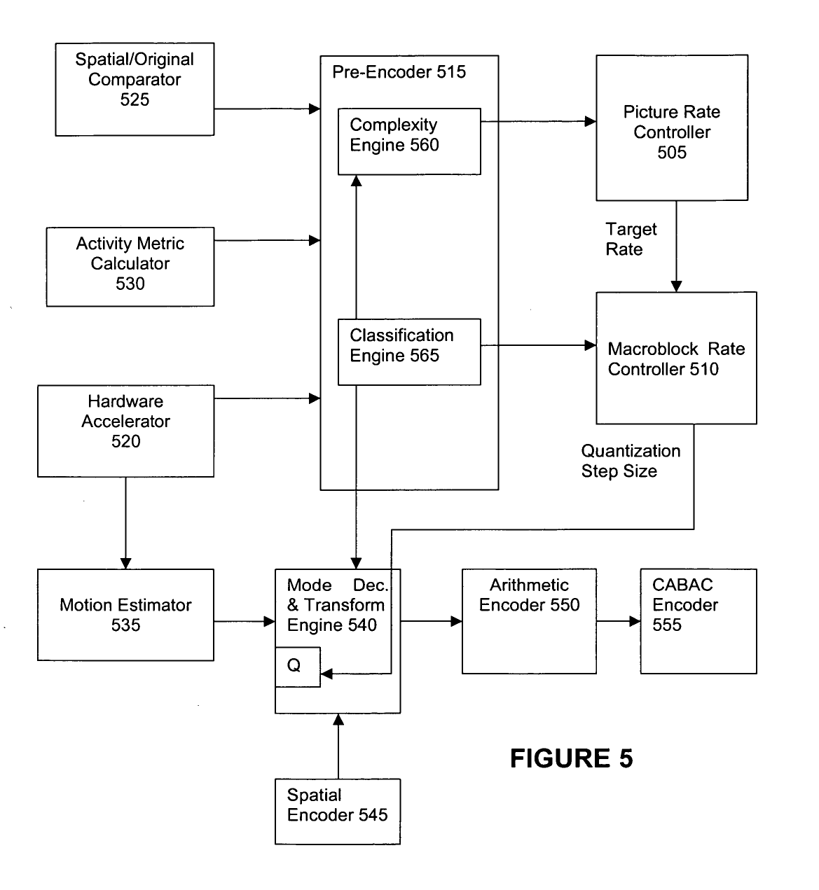

Referring now to FIG. 5, there is illustrated a block diagram of an exemplary system 500 for encoding video data in accordance with an embodiment of the present invention. The system 500 comprises a picture rate controller 505, a macroblock rate controller 510, a pre-encoder 515, hardware accelerator 520, spatial from original comparator 525, an activity metric calculator 530, a motion estimator 535, a mode decision and transform engine 540, an arithmetic encoder 550, and a CABAC encoder 555.

The picture rate controller 505 can comprise software or firmware residing on an external master system. The macroblock rate controller 510, pre-encoder 515, spatial from original comparator 525, mode decision and transform engine 540, spatial predictor 545, arithmetic encoder 550, and CABAC encoder 555 can comprise software or firmware residing on computer system 100. The pre-encoder 515 includes a complexity engine 560 and a classification engine 565. The hardware accelerator 520 can either be a central resource accessible by the computer system 100 or at the computer system 100.

The hardware accelerator 520 can search the original reference pictures for candidate blocks that are similar to blocks 430 in the pictures 115 and compare the candidate blocks CB to the blocks 430 in the pictures. The hardware accelerator 520 then provides the candidate blocks and the comparisons to the pre-encoder 515. The hardware accelerator 520 can comprise and/or operate substantially like the hardware accelerator described in “Systems, Methods, and Apparatus for Real-Time High Definition Encoding”, U.S. Application for patent Ser. No. ______, (attorney docket number 16285US01, filed ______, by ______, which is incorporated herein by reference for all purposes.

The spatial from original comparator 525 examines the quality of the spatial prediction of macroblocks in the picture, using the original picture and provides the comparison to the pre-encoder 515. The spatial from original comparator 525 can comprise and/or operate substantially like the spatial from original comparator 525 described in “Open Loop Spatial Estimation”, U.S. Application for patent Ser. No. ______, (attorney docket number 16283US01), filed ______, by ______, which is incorporated herein by reference for all purposes.

The pre-encoder 515 estimates the amount of data for encoding each macroblock of the pictures, based on the data provided by the hardware accelerator 520 and the spatial from original comparator 525, and whether the content in the macroblock is perceptually sensitive. The pre-encoder 515 estimates the amount of data for encoding the picture 115, from the estimates of the amounts of data for encoding each macroblock of the picture.

The pre-encoder 515 comprises a complexity engine 560 that estimates the amount of data of data for encoding the pictures, based on the results of the hardware accelerator 520 and the spatial from original comparator 525. The pre-encoder 515 also comprises a classification engine 565. The classification engine 565 classifies certain content from the pictures that is perceptually sensitive, such as human faces, where additional data for encoding is desirable.

Where the classification engine 565 classifies certain content from pictures 115 to be perceptually sensitive, the classification engine 565 indicates the foregoing to the complexity engine 560. The complexity engine 560 can adjust the estimate of data for encoding the pictures 115. The complexity engine 565 provides the estimate of the amount of data for encoding the pictures by providing an amount of data for encoding the picture with a nominal quantization parameter Qp. It is noted that the nominal quantization parameter Qp is not necessarily the quantization parameter used for encoding pictures 115.

The picture rate controller 505 provides a target rate to the macroblock rate controller 510. The motion estimator 535 searches the vicinities of areas in the reconstructed reference picture that correspond to the candidate blocks CB, for reference blocks that are similar to the blocks 430 in the plurality of pictures.

The search for the reference blocks by the motion estimator 535 can differ from the search by the hardware accelerator 520 in a number of ways. For example, the reconstructed reference picture and the picture can be full scale, whereas the hardware accelerator 520 searches original reference pictures and pictures that are reduced scale. Additionally, the blocks 430 can be smaller partitions of the blocks by the hardware accelerator 520. For example, the hardware accelerator 520 can use a 16×16 block, while the motion estimator 535 divides the 16×16 block into smaller blocks, such as 4×4 blocks. Also, the motion estimator 535 can search the reconstructed reference picture with ¼ pixel resolution.

The spatial predictor 545 performs the spatial predictions for blocks 430. The mode decision & transform engine 540 determines whether to use spatial encoding or temporal encoding, and calculates, transforms, and quantizes the prediction error E from the reference block. The complexity engine 560 indicates the complexity of each macroblock at the macroblock level based on the results from the hardware accelerator 520 and the spatial from original comparator 525, while the classification engine 565 indicates whether a particular macroblock contains sensitive content. Based on the foregoing, the complexity engine 560 provides an estimate of the amount of bits that would be required to encode the macroblock. The macroblock rate controller 510 determines a quantization parameter and provides the quantization parameter to the mode decision & transform engine 540. The mode decision & transform engine 540 comprises a quantizer Q. The quantizer Q uses the foregoing quantization parameter to quantize the transformed prediction error.

The mode decision & transform engine 540 provides the transformed and quantized prediction error E to the arithmetic encoder 550. Additionally, the arithmetic encoder 550 can provide the actual amount of bits for encoding the transformed and quantized prediction error E to the picture rate controller 505. The arithmetic encoder 550 codes the quantized prediction error E into bins. The CABAC encoder 555 converts the bins to CABAC data. The actual amount of data for coding the macroblock can also be provided to the picture rate controller 505.

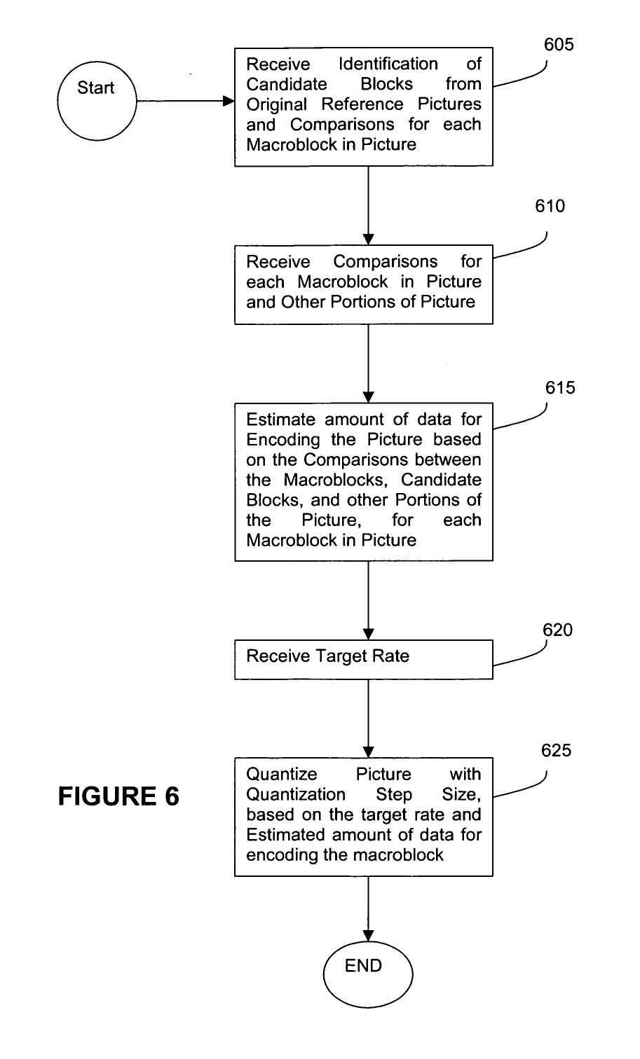

Referring now to FIG. 6, there is illustrated a flow diagram for encoding video data in accordance with an embodiment of the present invention. At 605, an identification of candidate blocks from original reference pictures and comparisons are received for each macroblock of the picture from the hardware accelerator 520. At 610, comparisons for each macroblock of the picture to other portions of the picture are received from the spatial from original comparator 525. At 615, the pre-encoder 515 estimates the amount of data for encoding the picture based on the comparisons of the candidate blocks to the macroblocks, and other portions of the picture to the macroblocks.

At 620, the macroblock rate controller 510 receives a target rate for encoding the picture. At 625, transformation values associated with each macroblock of the picture 115 are quantized with a quantization step size, wherein the quantization step size is based on the target rate and the estimated amount of data for encoding the macroblock.

The embodiments described herein may be implemented as a board level product, as a single chip, application specific integrated circuit (ASIC), or with varying levels of the decoder system integrated with other portions of the system as separate components.

The degree of integration of the decoder system may primarily be determined by speed and cost considerations. Because of the sophisticated nature of modern processor, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware. For example, the macroblock rate controller 510, pre-encoder 515, spatial from original comparator 525, activity metric calculator 530, motion estimator 535, mode decision and transform engine 540, arithmetic encoder 550, and CABAC encoder 555 can be implemented as firmware or software under the control of a processing unit in the encoder 110. The picture rate controller 505 can be firmware or software under the control of a processing unit at the master 105. Alternatively, the foregoing can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on the AVC encoding standard, the invention can be applied to a video data encoded with a wide variety of standards.

Therefore, it is intended that the present invention not be limited to the particular embodiment disclosed, but that the present invention will include all embodiments falling within the scope of the appended claims.

1. A method for encoding a picture, said method comprising:
estimating an amount of data for encoding a portion of the picture;
receiving a target rate for encoding the picture; and
lossy encoding the portion of the picture, based on the target rate and the estimated amount of data for encoding the portion of the picture.

2. The method of claim 1, further comprising estimating an amount of data for encoding the picture, wherein estimating the amount of data for encoding the picture comprises estimating the amount of data for encoding the portion of the picture.

3. The method of claim 1, wherein estimating an amount of data for encoding the portion of the picture further comprises:
receiving an identification of a candidate block from at least one original reference picture;
estimating the amount of data for encoding the portion of the picture based on a comparison of the candidate block and the portion of the picture.

4. The method of claim 1, wherein estimating the amount of data for encoding the portion of the picture further comprises:
comparing the portion of the picture to pixels generated from another portion of the picture.

5. The method of claim 1, wherein lossy encoding the portion of the picture further comprises:
quantizing transformation values associated with the portion of the picture.

6. The method of claim 1, wherein lossy encoding the portion of the picture further comprises:
quantizing transformation values associated with the portion of the picture with a quantization step size, wherein the quantization step size is based on the target rate and the estimated amount of data for encoding the picture.

7. A computer system for encoding a picture, said system comprising:
a processor for executing a plurality of instructions;
a memory for storing the plurality of instructions, wherein execution of the plurality of instructions by the processor causes:
estimating an amount of data for encoding a portion of the picture;
receiving a target rate for encoding the picture; and
lossy encoding the portion of the picture, based on the target rate and the estimated amount of data for encoding the portion of the picture.

8. The computer system of claim 7, wherein execution of the instructions also causes estimating an amount of data for encoding the picture, wherein estimating the amount of data for encoding the picture comprises estimating the amount of data for encoding the portion of the picture.

9. The computer system of claim 7, wherein estimating an amount of data for encoding the portion of the picture further comprises:
receiving an identification of a candidate block from at least one original reference picture; and
estimating the amount of data for encoding the portion of the picture based on a comparison of the candidate block and the portion of the picture.

10. The computer system of claim 7, wherein estimating the amount of data for encoding the portion of the picture further comprises:
comparing the portion of the picture to another portion of the picture.

11. The computer system of claim 7, wherein lossy encoding the portion of the picture further comprises:
quantizing transformation values associated with the portion of the picture.

12. The computer system of claim 7, wherein lossy encoding the portion of the picture further comprises:
quantizing transformation values associated with the portion of the picture with a quantization step size, wherein the quantization step size is based on the target rate and the estimated amount of data for encoding the picture.
